(19) United States
(12) Patent Application Publication
(10) Pub. No.: US 2005/0079106 A1
(43) Pub. Date: Apr. 14, 2005

(54) Robotic filling device

(76) Inventors: Rodney W. Baker, Westminster, MD (US); Grayson Keith, Taneytown, MD (US)

Correspondence Address: WHITEFORD, TAYLOR & PRESTON, LLP;ATTN: GREGORY M STONE, SEVEN SAINT PAUL STREET, BALTIMORE, MD, 21202-1626, US

(21) Appl. No.: 10/961,422

(22) Filed: Oct. 8, 2004

Related U.S. Application Data
(60) Provisional application No. 60/510,297, filed on Oct. 10, 2003.

(51) Int. Cl. B01L 3/00

(52) U.S. Cl. 422/100

(57) ABSTRACT

A method and system for filling small volume containers, tubes, and wells while maintaining a clean room environment around such containers, tubes, and wells by isolating all engaging moving components of the drive mechanism from the environmental area containing the containers, tubes, or wells. A unitary nozzle support arm extends through a base unit housing the drive mechanism and out over the containers, tubes, or wells intended to be filled. A nozzle mounted to the support arm is preferably in fluid communication with a source of the fluid that is to be analyzed. Optionally, such source may comprise an electronically controlled pump which interfaces with the control unit for the filling system so that both components may be controlled from a single operator interface.

### CROSS REFERENCE TO RELATED APPLICATION

This application is based upon and claims benefit of copending and co-owned U.S. Provisional Patent Application Ser. No. 60/510,297 entitled “ROBOTIC FILLING DEVICE,” filed with the U.S. Patent and Trademark Office on Oct. 10, 2003 by the inventors herein, the specification of which is incorporated herein by reference.

### FIELD OF THE INVENTION

The present invention relates to filling methods and apparatuses, and more particularly to a method and system for filling fluid sample receptacles with small amounts of fluid while maintaining a clean room environment around such receptacles.

### BACKGROUND OF THE INVENTION

Prior devices are known for filling small containers, tubes, or wells with fluid material, for example for purposes of conducting analyses of biological specimens. Often such instruments employ a pipette or similarly configured dispensing tube which is moved over the containers, tubes, or wells to dispense the desired volume into each such container, tube, or well. However, in most such applications, it is necessary to maintain a clean room environment, the conditions for which may be difficult to obtain when the driving mechanisms for moving the pipette may themselves generate particulate material which may contaminate the specimens under analysis. It would therefore be advantageous to provide a method and system for filling such containers, tubes, or wells that does not allow particulate material ordinarily generated by the movement of mechanical components of a drive system to enter the environment of the specimens.

### SUMMARY OF THE INVENTION

The present invention provides a method and system for filling small volume containers, tubes, and wells while maintaining a clean room environment around such containers, tubes, and wells. It provides three axes of operation, but isolates all engaging moving components of the drive mechanism from the environmental area containing the containers, tubes, or wells. A unitary nozzle support arm extends through a base unit housing the drive mechanism and out over the containers, tubes, or wells intended to be filled. A nozzle mounted to the support arm is preferably in fluid communication with a source of the fluid that is to be analyzed. Optionally, such source may comprise an electronically controlled pump which interfaces with the control unit for the filling system so that both components may be controlled from a single operator interface.

### BRIEF DESCRIPTION OF THE DRAWINGS

Other objects, features, and advantages of the present invention will become more apparent from the following detailed description of the preferred embodiment and certain modifications thereof when taken together with the accompanying drawings in which:

FIG. 1 is a side, partial sectional view of a first embodiment of a filler incorporating the invention.

FIG. 2 is a top, sectional view of the filler of FIG. 1.

FIG. 3 is a front view of the filler of FIG. 1.

FIG. 4 is a rear, sectional view of the filler of FIG. 1.

FIG. 5 is a top, sectional view of a second embodiment of a filler incorporating the invention.

FIG. 6 is a side, partial sectional view of the filler of FIG. 5.

### DETAILED DESCRIPTION OF THE PREFERRED EMBODIMENTS

The invention summarized above and defined by the enumerated claims may be better understood by referring to the following description, which should be read in conjunction with the accompanying drawings in which like reference numerals are used for like parts. This description of an embodiment, set out below to enable one to build and use an implementation of the invention, is not intended to limit the enumerated claims, but to serve as a particular example thereof. Those skilled in the art should appreciate that they may readily use the conception and specific embodiment disclosed as a basis for modifying or designing other methods and systems for carrying out the same purposes of the present invention. Those skilled in the art should also realize that such equivalent assemblies do not depart from the spirit and scope of the invention in its broadest form.

The filling device disclosed herein is preferably configured for use in a class 100 clean room, and is provided with three axes of motion the driving element of which are mounted within a rigid enclosure, preferably a 304 stainless steel enclosure. A nozzle support arm extends through a side of the enclosure and is preferably sealed at its pass-through point with a floating seal that enables movement of the shaft along the three axes. Thus, the nozzle support arm can move in and out, left and right, and up and down in order to fit into a variety of liquid receivers and receiver arrays. The filling device is configured such that no particulate generating components are in the environmental area that includes the fluid receiver, thus facilitating the ability to provide a sterile filling environment. The filling device is operable through a programmable controller which optionally may simultaneously control a separate fluid pump which a user would use to provide fluid through the nozzle of the filling device. Preferably, an operator interface screen is mounted on the enclosure to allow the operator to interface with the programmable controller and to enter tray arrays and/or teach the system tray arrays. Preferably, step-by-step instructions are displayed on the screen to guide the operator through setup and operation.

In use, an operator preferably places a try in a corner locating fixture mounted on a base of the filling device. A sensor, such as an optical sensor, pressure sensor, or the like, situated on the locating fixture detects that a tray is in the fixture and allows the operator to proceed with a filling operation. In order to properly fill the tray, the operator may select a preloaded filling routine that is particularly adapted for the tray array, enter new data in a new filling routine, or teach the array to the filler. Once the array has been loaded, the operator may “dry cycle” the filler to test the position information. After the “dry cycle,” a full filling cycle may be run or adjustments may be made to correct any misalignments. The filling operation may begin by the operator's selection of a run mode of operation. Pressing a “Start” button (or other initiating interface) begins the cycle for filling the tray. When the cycle is complete and all receivers are filled, the nozzle preferably moves to a home position and stops. The screen then instructs the operator to remove the filled tray and choose to insert another tray or stop running. Preferably, each drive is provided a proximity sensor to allow the programmable logic controller to confirm that the home position of nozzle 130 has been achieved upon start up.

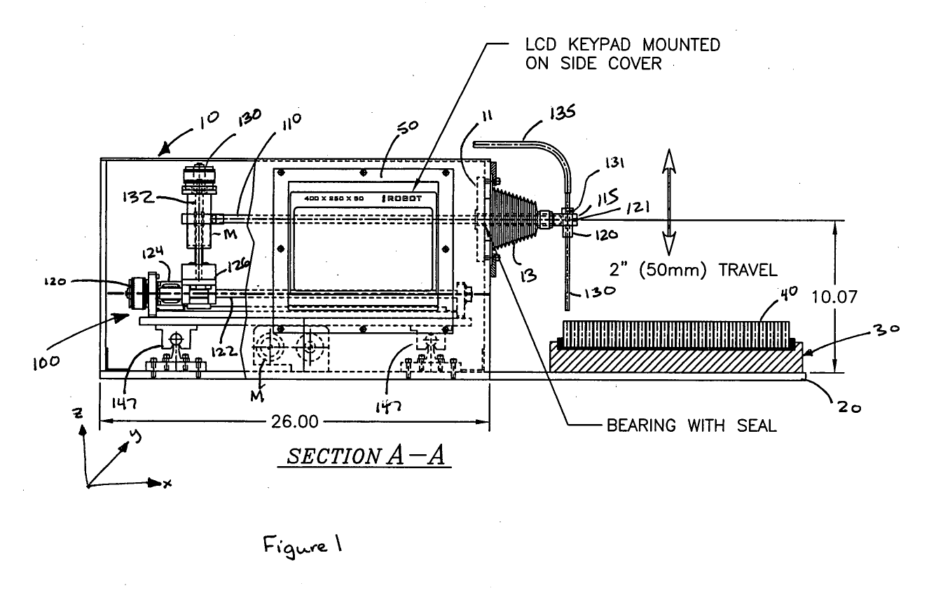

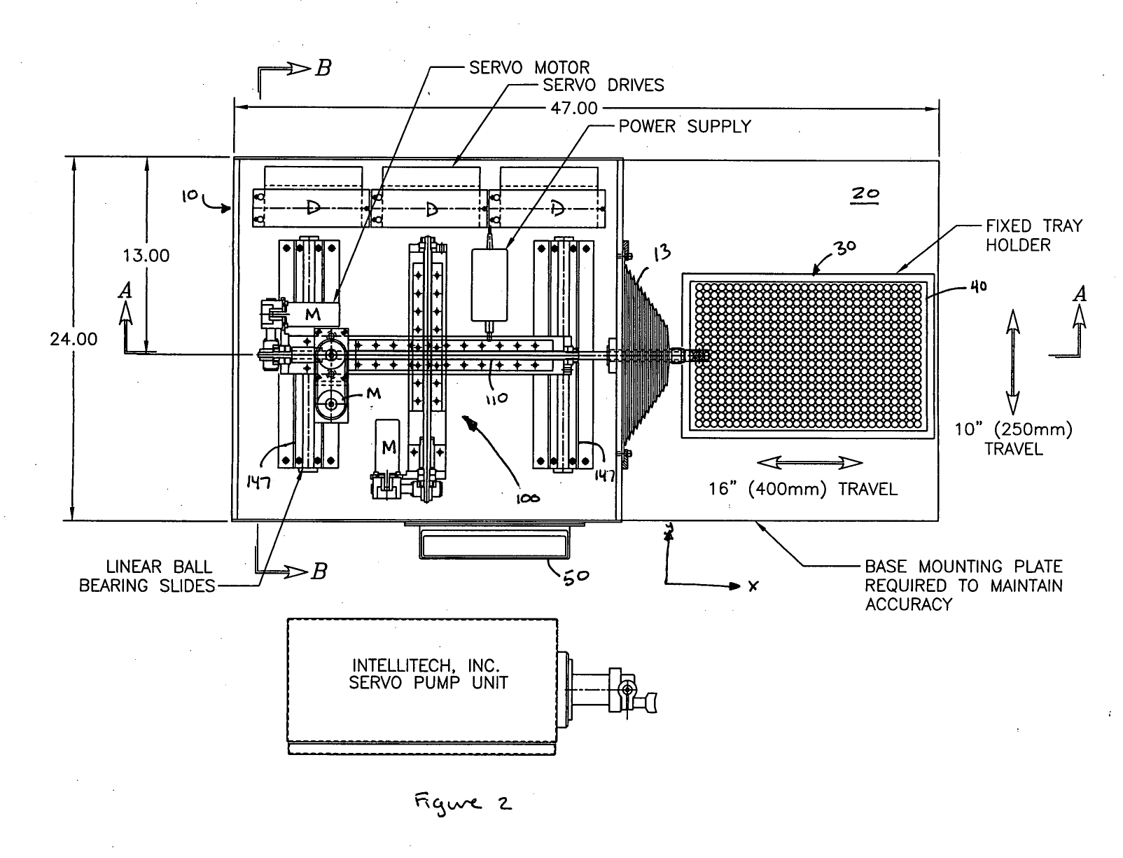

As shown in the side view of FIG. 1 and the top down view of FIG. 2, in a first embodiment the filling device comprises an enclosure 10 mounted to a base member 20 preferably comprised of steel, aluminum, combinations thereof, or other rigid material capable of easy sterilization. Base member 20 is preferably provided a relatively small profile so that the entire structure of the filling device may be placed in a clean hood during operation. Affixed to base 20 is a support tray 30 configured for holding a multi-well microplate, multi-tube tray, or similarly configured multiple fluid compartment container 40. Preferably, support tray 30 is provided with an alignment guide at one corner of the position intended for container 40. When container 40 is placed on support tray 30, it may be moved against the corner alignment guide such that all containers may have a common reference point identifiable by the automatic controller of the filling device. Preferably, a sensor, such as an optical sensor, is provided below or within a top surface of support tray 30 and is positioned adjacent to the corner alignment guide so as to detect the presence or absence of a container 40 on support tray 30, and in turn prevent dispensing of fluid from nozzle 130 if no container is present.

Preferably mounted on the side of enclosure 10 is a control panel 50 allowing an operator to interface with the automatic controller of the filling device.

Housed within enclosure 10 is a three axis drive unit (shown generally at 100) which is configured to drive a nozzle support shaft 110 through three generally orthogonal axes. One end of nozzle support shaft 110 extends through a wall of enclosure 10 and terminates in a blank support 115 that is preferably threaded to the end of nozzle support shaft 110, and is provided a central hole configured to receive nozzle blank 120. A set screw 121 may be provided locking blank 120 within blank support 115. Blank 120 likewise is provided a central hole configured to receive nozzle 130. A second set screw 131 may be provided locking nozzle 130 within nozzle blank 120. Tubing 135 may be provided to connect nozzle 130 to a source of fluid intended for dispensing to container 40.

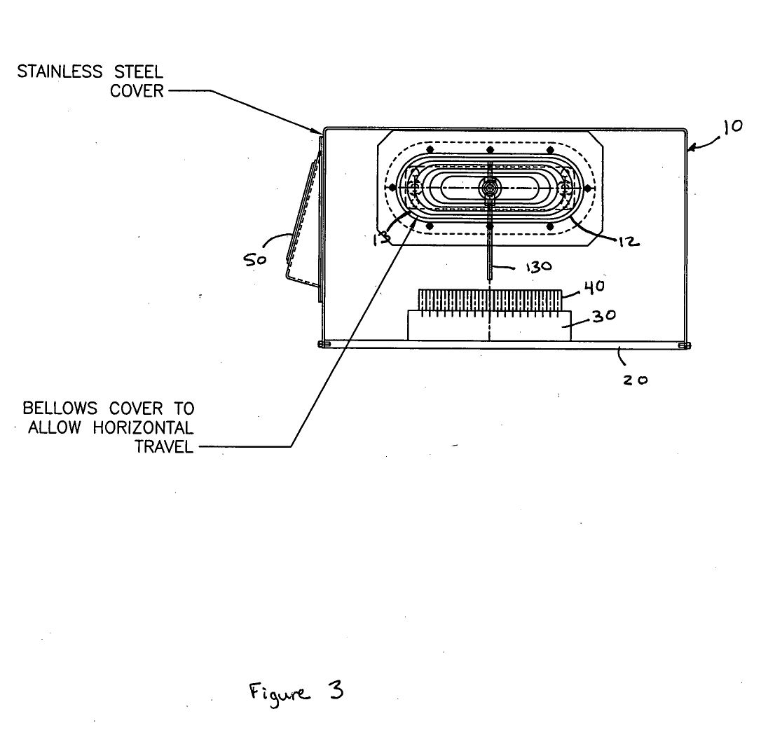

Preferably, the point at which nozzle support shaft 110 passes through housing 10 includes a bearing having a wiper or similarly configured seal which prevents particulates from within enclosure 10 from escaping into the filling environment outside of enclosure 10. Surrounding the bearing is a sliding seal 11 which is mounted within brackets (not shown) that enable the seal to move up and down and side to side while being held against the interior wall of enclosure 10. As shown in FIG. 3, enclosure 10 is provided an opening 12 in its sidewall which enables up and down and side to side movement of nozzle support shaft 110. Sliding seal 11 is sufficiently large so as to completely cover opening 12 at all times, thus preventing entry of particulate matter into the filling environment from the interior of enclosure 10. A flexible bellows-type member 13 is also preferably clamped to the exterior wall of enclosure 10 and encloses the point at which nozzle support shaft 110 passes through the wall of enclosure 10.

Drive mechanism 100 is configured to allow nozzle support shaft 110 to move in three generally orthogonal axes. As shown in FIG. 1, a first belt-driven drive pulley assembly 120 is operatively engaged with an x-axis screw 122. An x-axis ball nut 124 engages x-axis screw 122 such that rotation of screw 122 causes ball nut 124 to travel along screw 122. X-axis carriage 126 is preferably affixed to ball nut 124, such that movement of ball nut 124 along screw 122 likewise causes movement of x-axis carriage 126 in the x-direction, which is ultimately translated to movement of nozzle support shaft 110 and thus nozzle 130 in the x-direction.

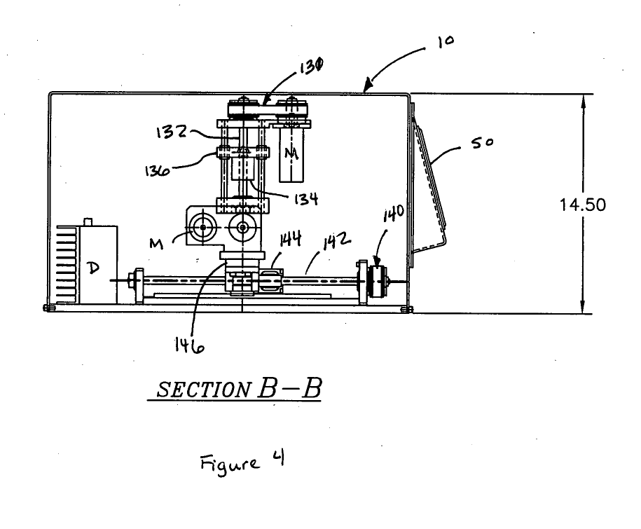

With particular reference to the rear view of FIG. 4, mounted atop x-axis carriage 126 is a second belt-driven drive pulley assembly 131 operatively engaged with a z-axis screw 132. A z-axis ball nut 134 engages z-axis screw 132 such that rotation of screw 132 causes ball nut 134 to travel along screw 132. Nozzle shaft mounting plate 136 is preferably affixed to ball nut 134, such that movement of ball nut 134 along screw 132 likewise causes movement of nozzle shaft mounting plate 136 in the z-direction, which is ultimately translated to movement of nozzle support shaft 110 and thus nozzle 130 in the z-direction.

With particular reference to the top view of FIG. 2 and the rear view of FIG. 4, the above-described x- and z-direction drive units are mounted atop a similarly configured y-direction drive unit including a third belt-driven drive pulley assembly 140 operatively engaged with a y-axis screw 142. A y-axis ball nut 144 engages y-axis screw 142 such that rotation of screw 142 causes ball nut 144 to travel along screw 142. Y-axis carriage 146 is preferably affixed to ball nut 144, such that movement of ball nut 144 along screw 142 likewise causes movement of y-axis carriage 146 in the y-direction, which is ultimately translated to movement of nozzle support shaft 110 and thus nozzle 130 in the y-direction. Additional support rails 147 are preferably provided which include slide members allowing linear movement of the entire drive assembly in the y-direction while providing additional structural support to the free ends of such drive assembly.

Each of the drive assemblies preferably includes a servo motor M which drivingly engages one of the drive pulleys in each respective drive pulley assembly, each of which is preferably driven by a servo drive D. While each drive pulley assembly is depicted as a belt-driven system, a gear drive or alternately configured drive mechanism may likewise be provided for one or more of the drive units, so long as such drive mechanism is capable of sufficiently refined movement to enable placement of the nozzle over each opening of container 40. Each servo drive D is preferably networked to a programmable logic controller with which a user may interface via control panel 50.

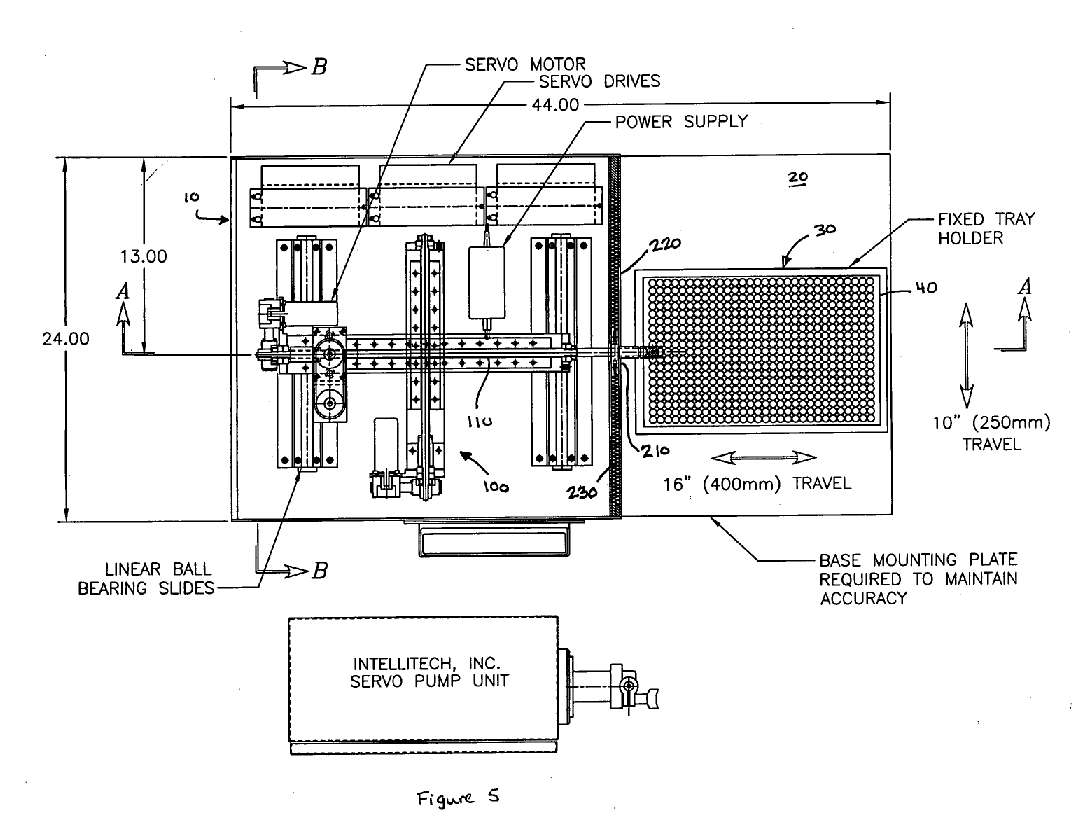

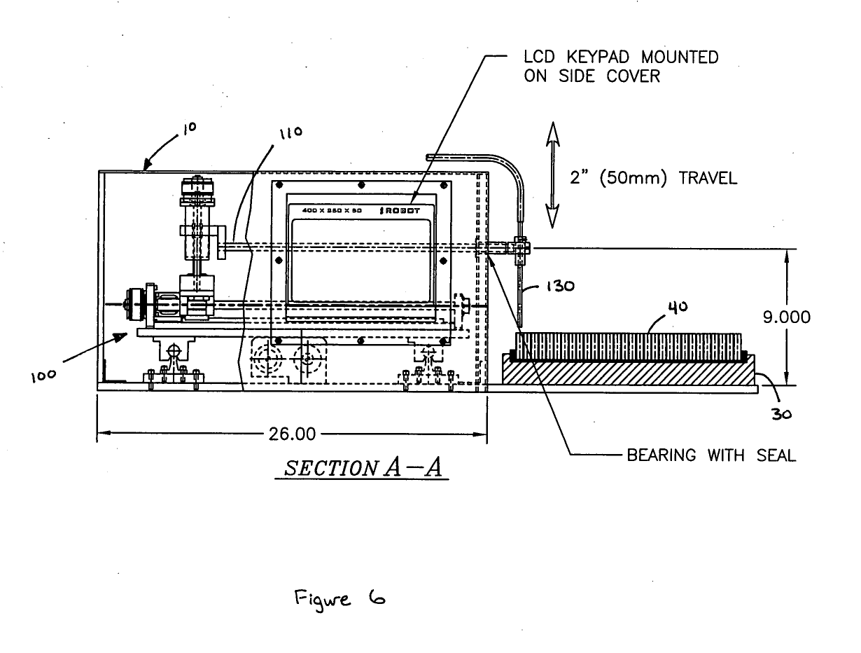

As shown in the alternate embodiment depicted in FIGS. 5 and 6, an alternate sealing member assembly may be provided along the wall through which nozzle support rod 110 passes to enable movement of nozzle support rod 110 through three axes while ensuring that a tight seal is maintained such that particulate material from within enclosure 10 does not enter into the filling environment. As with the above-described embodiment, a bearing having a wiper or other sealing member is provided at the point at which nozzle support rod 110 passes through the wall of enclosure 10. Such bearing is preferably mounted within a moveable seal 210 which is moveable throughout an opening 220 in the sidewall of enclosure 10. Preferably surrounding moveable seal 210 is a resilient, compressible, accordion-like sealing member 230 which simultaneously seals opening 220 to prevent particulates within enclosure 10 from entering the filling environment and enables nozzle support shaft 110 to move through the Y and Z axes. With the construction shown in this alternate embodiment, nozzle 130 may achieve a home position that is closer to enclosure 10 than the previously-described embodiment, in turn enabling a smaller profile for the entire filler assembly.

As mentioned briefly above, a programmable logic controller is preferably provided enabling an operator to provide instructions to the filler concerning the configuration of container 40, and to provide instructions to an electronically controlled pump in fluid communication with nozzle 130 to control the dispensing of the desired fluid into container 40. Each of servo drives D is coupled to the programmable logic controller such that each of the drives, and thus movement of nozzle support rod 110 along each axis, may be independently controlled. Each of the motors M are preferably provided a feedback cable in electrical communication with its respective drive D enabling an encoder to confirm that a desired movement of nozzle support rod 110 in a particular axial direction has been achieved. Moreover, data ports are preferably provided enabling interfacing the programmable logic controller of the filler unit with an external electronically controlled pump in fluid communication with nozzle 130. For example, the programmable logic controller may transmit both power and control signals (in the form of discrete I/O signals between the pump and filler units) to instruct the pump to being pumping the fluid intended for container 40, and to likewise instruct the pump to stop pumping such fluid.

Optionally, before initiating a filling operation, a filler operator may interface with the programmable logic controller to initiate a calibration and setup process which will aid in the automated filling of a container 40, for example, a multi-well microplate. Upon powering up the filler mechanism, the programmable logic controller preferably causes each of the drive motors to move nozzle 130 to a predetermined home position, for example, at a fixed location with respect to the corner of base 20 at which the alignment guide is located, such that the home position will be in the same position with respect to the corresponding corner of any container 40 placed on base 20, irrespective of such container's configuration. After all motors have caused the respective drives to move nozzle 130 to its predetermined home position, a user may operate directional controls on control panel 50 causing nozzle 130 to move along the X and Y axes until nozzle 130 is positioned directly over the container well, tube, or other portion that is closest to the previously mentioned corner of container 40. Once the position of such first well is achieved, the operator may instruct the filler control to save that position as a coordinate. The operator may then continue to operate the directional controls to move nozzle 130 over a well immediately adjacent the first well along either the X or Y axis, and save that second position as a coordinate. Next, the operator may operate the directional controls to move nozzle 130 over the remaining well immediately adjacent the first well along the X or Y axis, and save that third position as a coordinate. Following the entry of those coordinates, the system preferably prompts the operator to enter an array size (i.e., input the total number of wells in the container, or the total number of wells along the X axis and the total number of wells along the Y axis). Once all of the data has been input, the operator may save the configuration with a particular file designation corresponding to the specific container configuration, such that when future containers of the same configuration need to be filled, the operator may simply recall the previously saved configuration without proceeding through the above-described calibration process.

Following calibration, the operator may have the option of performing a dry run of the filling operation in which the nozzle 130 traverses the container and cycles through its programmed filling movements without actually dispensing fluid so as to confirm that the system is properly aligned and calibrated. Alternate to or following such dry run, the operator may instruct the programmable logic controller to initiate the filling operation, thus sending a start signal to the pump to begin pumping fluid to nozzle 130 and cycling the filler through its various positioning movements to move nozzle 130 to its various dispensing positions above container 40. Again, as all drive elements are housed within enclosure 10, such positioning movements are achieved without positioning any engaging moveable drive elements in the environmental area of the filling operation.

The invention has been described with reference to certain preferred embodiments. While specific values, relationships, materials and steps have been set forth for purposes of describing concepts of the invention, it will be appreciated by persons skilled in the art that numerous variations and/or modifications may be made to the invention as shown in the specific embodiments without departing from the spirit or scope of the basic concepts and operating principles of the invention as broadly described. It should be recognized that, in the light of the above teachings, those skilled in the art can modify those specifics without departing from the invention taught herein. Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. It is intended to include all such modifications, alternatives and other embodiments insofar as they come within the scope of the appended claims or equivalents thereof. It should be understood, therefore, that the invention may be practiced otherwise than as specifically set forth herein. Consequently, the present embodiments are to be considered in all respects as illustrative and not restrictive.

1. An apparatus for filling a receptacle in a clean room environment comprising:
a drive unit operatively engaged with a nozzle support rod and configured to move said nozzle support rod in three dimensions;
a housing enclosing said drive unit, said housing having an opening in a first wall thereof through which said nozzle support rod may translate in three dimensions; and
a sealing member disposed between said opening in said first wall of said housing and said nozzle support shaft, said sealing member being configured to prevent particulate matter inside of said housing from exiting said housing.
